(19) United States
(12) Patent Application Publication
(10) Pub. No.: US 2021/0110805 A1
(43) Pub. Date: Apr. 15, 2021

(54) APPARATUS FOR COLLECTING SOUNDS IN WIDE AREA WITHOUT LOSS OF SOUNDS, AND USE METHOD THEREFOR

(71) Applicant: Geum Cheol KIM, Incheon (KR)

(72) Inventor: Geum Cheol KIM, Incheon (KR)

(21) Appl. No.: 16/603,178

(22) PCT Filed: Apr. 6, 2018
(86) PCT No.: PCT/KR2018/004101

§ 371 Date: Oct. 4, 2019

(30) Foreign Application Priority Data
Apr. 6, 2017 (KR) 10-2017-0044944

(51) Int. Cl. G10K 11/08; G10L 21/0216; G10L 21/0316

(52) U.S. Cl. CPC G10K 11/08; G10L 21/0316; G10L 21/0216

(57) ABSTRACT

The present invention relates to an apparatus and a method for collecting unspecific and various sounds, occurring in the field of crime prevention, guard, or the like, in a wide area by means of a microphone without any loss, and provides means for an apparatus and a method for collection using a single microphone and for an apparatus and a method for collection using multiple microphones.

### TECHNICAL FIELD

The present invention relates to an apparatus and a method for collection of all sounds generated over a wide area, in particular, unspecified, unpredictable and uncontrolled sounds having different characteristics in fields of crime prevention, precaution or guard, etc., using a microphone without loss thereof.

### BACKGROUND ART

For detection of sound in fields of crime prevention, security, guard, precaution, etc., the sound cannot be defined or adjusted, occurrence of sound cannot be predicted or controlled, and a sound volume may have a wide range from tiny sound to very loud sound. Further, even the same sound source may have a large difference in loudness modulation (or pitch) and/or such difference may occur for a short period of time, and a plurality of sounds may be mixed. Further, since a situation in an area under observation should be judged using sound having specific features such as being unable to restrict a sound occurrence point, all sounds generated over a wide area need to be collected without transient loss thereof.

Korean Patent Registration No. 10-1384761 discloses an optical fiber sensor as a means to extend a surveillance area by overcoming a spatial limitation of a microphone in collecting sounds while collecting the sounds in fields of crime prevention, precaution, etc. However, the optical sensor may sense a sound pressure but cannot collect sound. Since Korean Patent Registration No. 10-1384781 proposed a sound collection means using the optical sensor instead of a microphone, a means for collecting all sounds generated over a broad area under observation without transient loss thereof is not provided.

Korean Patent Registration No. 10-1519430 discloses an apparatus that selects sound generated in a preset direction among all sounds collected by a microphone, amplifies the sound after removing howls, and directly outputs the same to a speaker. Since a sound selection means in Korean Patent Registration No. 10-1519460 selects specific sound generated in a predetermined direction, all sounds generated over a broad area could not be collected without loss thereof. Further, with regard to a sound amplification means, Korean Patent Registration No. 10-1519430 did not specify a means that amplifies the collected sound at a plurality amplification factors and then separately stores the amplified sounds in a memory unit, a means to select one among the amplified sounds at a plurality of amplification factors, a means to determine whether or not the amplified sounds are beyond a collection range, etc. Therefore, a means for collecting all sounds generated over a broad area without transient loss thereof is not provided.

Korean Utility Model Laid-Open Publication No. 20-2010-0003992 discloses an apparatus that amplifies sound collected by a microphone installed in the vicinity of a specific sound source set in a memory and then determines whether or not the amplified sound is a target sound in comparison with a level of sound set in the memory. However, since a sound collection means in Korean Utility Laid-Open Publication No. 20-2010-0003992 has the microphone located in the vicinity of the specific sound source, the means cannot collect all sounds generated over a broad area without loss thereof. Further, with regard to a sound amplification means, Korean Utility Model Laid-Open Publication No. 20-2010-0003992 did not specify a means that amplifies the collected sound at a plurality of amplification factors and then separately stores the amplified sounds in a memory unit, a means to select one among the amplified sounds at a plurality of amplification factors, a means to determine whether or not the amplified sound is beyond a collection range, etc. Therefore, a means for collecting all sounds generated over a broad area without transient loss thereof is not provided.

Further, Korean Patent Registration No. 10-1547729 and U.S. Pat. No. 5,696,356 were proposed for the purpose of collecting sounds. However, these patents relate to a mechanical device to collect sound in a wide area, which is fundamentally different means from the means proposed in the present invention as an electronic device does not include any signal processing means.

Accordingly, an apparatus and. a method for collection of all sounds generated in fields of crime prevention and precaution over a broad area by a microphone without transient loss thereof are required.

### DISCLOSURE

### Technical Problem

Accordingly, an object of the present invention is to provide an apparatus and a method for collection of all sounds generated over a broad area, in particular, unspecified, unpredictable and uncontrolled sounds having different characteristics in fields of crime prevention, precaution, etc., using a microphone without transient loss thereof.

### Technical Solution

In order to accomplish the above objects, there is provided an apparatus including: a single microphone to transfer sound collected from the surroundings to an amplification stage; the amplification stage that amplifies the sound transferred from the microphone at a plurality of amplification factors and transfers the generated multiple sounds, that is, amplified sounds to a selection unit; the selection unit that separately stores the amplified sounds transferred from the amplification stage in a memory unit, while determining an amplitude of each amplified sound, adding information on the selected one amplified sound to a control signal and transmitting the control signal to a control unit; the memory unit that separately stores the amplified sounds transferred from the selection unit therein; and the control unit that searches the memory unit for the amplified sound corresponding to the information included in the control signal transmitted from the selection unit and controls the amplified sound. Further, there is provided a sound collection method using the above apparatus, which includes: transferring sound collected by the single microphone to the amplification stage; amplifying the sound at a plurality of amplification factors using the amplification stage and transferring the generated multiple sounds, that is, amplified sounds to the selection unit; separately storing the amplified sounds in the memory unit using the selection unit, while determining an amplitude of each amplified sound, adding information on the selected one amplified sound to a control signal, and transmitting the control signal to the control unit; searching the memory unit for the amplified sound corresponding to the information included in the control signal and controlling the amplified sound by the control unit, whereby a single sound collected by the single microphone is amplified into multiple sounds at a plurality of amplification factors, the amplified sounds are separately stored in the memory unit, while determining an amplitude of each amplified sound and controlling the amplified sound corresponding to the information on the selected one amplified sound, thereby collecting all sounds over a broad area without loss thereof.

Further, the apparatus of the present invention may include: a plurality of microphones to transfer sound collected from the surroundings to a plurality of amplification stages by one to one (1:1); the plurality of amplifiers stages that amplify the sound transferred from the plurality of microphones by one to one at a plurality of amplification factors and transfer the generated multiple sounds, that is, amplified sounds to a plurality of selection units by one to one; the plurality of selection units that separately store the amplified sounds transferred from the amplification stages in a memory unit by one to one, while determining an amplitude of each amplified sound, adding information on the plurality of amplified sounds selected by the number of the microphones to a plurality of control signals by one to one, and transmitting the control signals to a control unit; a single memory unit that separately stores the amplified sounds transferred from the selection units therein; and a single control unit that searches the memory unit for the amplified sounds corresponding to the information included in the control signals transmitted from the selection units by one to one and controls the amplified sounds. Further, the method of the present invention using the above apparatus may include: transferring the sounds collected by the plurality of microphones to the plurality of amplification stages corresponding to the microphones by one to one; amplifying the sounds received in the amplification stages by one to one at a plurality of amplification factors, respectively, using the amplification stages and transferring the generated multiple sounds, that is, amplified sounds to the plurality of selection units by one to one; separately storing the amplified sounds in the single memory unit using the plurality of selection units, while determining an amplitude of each amplified sound, adding information on the selected multiple amplified sounds to control signals by one to one, and transmitting the control signals to the control unit; searching the memory unit for the amplified sounds corresponding to the information included in the control signals, respectively, and controlling the amplified sounds by the control unit, whereby sounds collected by the plurality of microphones are amplified into multiple sounds, respectively, at a plurality of amplification factors, the amplified sounds are separately stored in the memory unit, while determining an amplitude of each amplified sound and controlling the amplified sounds corresponding to the information on the selected multiple amplified sounds, respectively, thereby collecting all sounds over a broad area without loss thereof.

Further, the apparatus of the present invention may include: a plurality of microphones to transfer sounds collected from the surroundings to an amplification stage and a fixed amplification unit by one to one; the amplification stage that amplifies the sound transferred from some among the plurality of microphones at a plurality of amplification factors and transfers the generated multiple sounds, that is, amplified sounds to a selection unit; the selection unit that separately stores the amplified sounds transferred from the amplification stage in a memory unit, while determining an amplitude of each amplified sound, adding information on the selected one amplified sound to a control signal and transmitting the control signal to a control unit; the fixed amplification unit that amplifies the sounds transferred from some other ones among the plurality of microphones into a single sound at a fixed amplification factor and transfers the amplified sound to an ADC unit; the ADC unit that stores the amplified sound transferred from the fixed amplification unit in the memory unit using ADC control signal; a single memory unit that separately stores the amplified sounds transferred from the selection unit and the amplified sound transferred from the ADC unit therein, respectively; and a single control unit that searches the memory unit for the amplified sound corresponding to the information included in the control signal transmitted from the selection unit and the amplified sound in response to the ADC unit, and controls the amplified sounds. Further, the sound collection method of the present invention using the above apparatus may include: transferring the sounds collected by some among the plurality of microphones to the amplification stage and the sounds collected by some other ones among the plurality of microphones to the fixed amplification unit, respectively; amplifying the sound received in the amplification stage at a plurality of amplification factors using the amplification stage and transferring the generated multiple sounds, that is, amplified sounds to the selection unit and, on the other hand, amplifying single sound received in the fixed amplification unit at a fixed amplification factor and transferring the amplified sound to the ADC unit; separately storing the amplified sounds in the single memory unit using the selection unit, while determining an amplitude of each amplified sound, adding information on the selected one amplified sound to a control signal and transmitting the control signal to the control unit and, on the other hand, storing the amplified sound received in the ADC unit in the memory unit using ADC control signal; searching the memory unit for the amplified sound corresponding to the information included in the control signal while searching the ADC unit for the stored amplified sound, and controlling the amplified sounds by the control unit, whereby sounds collected by some among the plurality of microphones are amplified into multiple sounds, respectively, at a plurality of amplification factors, the amplified sounds are separately stored in the memory unit, while determining an amplitude of each amplified sound and controlling the amplified sound corresponding to the information on the selected one amplified sound and, on the other hand, amplifying sounds collected from some other ones among the plurality of microphones into a single sound, storing the amplified sound and controlling the same, thereby collecting all sounds over a broad area without loss thereof.

### Advantageous Effects

Using only microphone may collect all sounds generated over a broad area, in particular, unspecific, unpredictable and uncontrollable sounds having different characteristics, without loss thereof.

### DESCRIPTION OF DRAWINGS

FIG. 1 is a configuration diagram illustrating an apparatus for collection of sound by a single microphone according to one embodiment of the present invention.

FIG. 2 is a configuration diagram illustrating an apparatus for collection of sound by a plurality of microphones according to one embodiment of the present invention.

FIG. 3 is a configuration diagram illustrating an apparatus for collection of sound by a plurality of microphones according to another embodiment of the present invention.

FIG. 4 is a flowchart of FIG. 1 according to the embodiment of the present invention.

FIG. 5 is a flowchart of FIG. 2 according to the embodiment of the present invention.

FIG. 6 is a flowchart of FIG. 3 according to the embodiment of the present invention.

FIG. 7 illustrates waveforms of amplified sounds at plurality of amplification factors and a collection range thereof according to the present invention.

FIG. 8 illustrates amplified sounds at a plurality of amplification to time segments according to the present invention.

### BEST MODE

According to one embodiment of the present invention, the apparatus may include: a single microphone to transfer sound collected from the surroundings to an amplification stage; the amplification stage that amplifies the sound transferred from the microphone at a plurality of amplification factors and transfers the generated multiple sounds, that is, amplified sounds to a selection unit; the selection unit that separately stores the amplified sounds transferred from the amplification stage in a memory unit, while determining an amplitude of each amplified sound, adding information on the selected one amplified sound to a control signal and transmitting the control signal to a control unit; the memory unit that separately stores the amplified sounds transferred from the selection unit therein; and the control unit that searches the memory unit for the amplified sound corresponding to the information included in the control signal transmitted from the selection unit and controls the amplified sound. Further, the sound collection method using the above apparatus according to the present invention may include: transferring sound collected by the single microphone to the amplification stage; amplifying the sound at a plurality of amplification factors using the amplification stage and transferring the generated multiple sounds, that is, amplified sounds to the selection unit; separately storing the amplified sounds in the memory unit using the selection unit, while determining an amplitude of each amplified sound, adding information on the selected one amplified sound to a control signal, and transmitting the control signal to the control unit; searching the memory unit for the amplified sound corresponding to the information included in the control signal and controlling the amplified sound by the control unit, whereby a single sound collected by the single microphone is amplified into multiple sounds at a plurality of amplification factors, the amplified sounds are separately stored in the memory unit, while determining an amplitude of each amplified sound and controlling the amplified sound corresponding to the information on the selected one amplified sound, thereby collecting all sounds over a broad area without loss thereof.

Further, according to another embodiment of the present invention, the apparatus may include: a plurality of microphones to transfer sound collected from the surroundings to a plurality of amplification stages by one to one; the plurality of amplification stages that amplify the sounds transferred from the plurality of microphones by one to one at a plurality of amplification factors and transfer the generated multiple sounds, that is, amplified sounds to a plurality of selection units by one to one; the plurality of selection units that separately store the amplified sounds transferred from the amplification stages in a memory unit by one to one, while determining an amplitude of each amplified sound, adding information on the plurality of amplified sounds selected by the number of the microphones to a plurality of control signals by one to one and transmitting the control signals to a control unit; a single memory unit that separately stores the amplified sounds transferred from the selection units therein; and a single control unit that searches the memory unit for the amplified sounds corresponding to the information included in the control signals transmitted from the selection units by one to one and controls the amplified sounds. Further, the sound collection method of the present invention using the above apparatus may include: transferring sounds collected by the plurality of microphones to the plurality of amplification stages corresponding to the microphones by one to one; amplifying the sounds received in the amplification stages by one to one at a plurality of amplification factors, respectively, using the amplification stages and transferring the generated multiple sounds, that is, amplified sounds to the plurality of selection units by one to one; separately storing the amplified sounds in the single memory unit using the plurality of selection units, while determining an amplitude of each amplified sound, adding information on the selected multiple amplified sounds to control signals by one to one, and transmitting the control signals to the single control unit; searching the memory unit for the amplified sounds corresponding to the information included in the control signals, respectively, and controlling the amplified sounds by the control unit, whereby sounds collected by the plurality of microphones are amplified into multiple sounds, respectively, at a plurality of amplification factors, the amplified sounds are separately stored in the memory unit, while determining an amplitude of each amplified sound and controlling the amplified sounds corresponding to the information on the selected multiple amplified sounds, respectively, thereby collecting all sounds over a broad area without loss thereof.

Further, according to another embodiment of the present invention, the apparatus may include: a plurality of microphones to transfer sound collected from the surroundings to an amplification stage and a fixed amplification unit by one to one; the amplification stage that amplifies the sound transferred from some among the plurality of microphones at a plurality of amplification factors and transfers the generated multiple sounds, that is, amplified sounds to a selection unit; the selection unit that separately stores the amplified sounds transferred from the amplification stage in a memory unit, while determining an amplitude of each amplified sound, adding information on the selected one amplified sound to a control signal and transmitting the control signal to a control unit; the fixed amplification unit that amplifies the sounds transferred from some other ones among the plurality of microphones into a single sound at a fixed amplification factor and transfers the amplified sound to an ADC unit; the ADC unit that stores the amplified sound transferred from the fixed amplification unit in the memory unit using ADC control signal; a single memory unit that separately stores the amplified sounds transferred from the selection unit and the amplified sound transferred from the ADC unit, respectively, therein; and a single control unit that searches the memory unit for the amplified sound corresponding to the information included in the control signal transmitted from the selection unit and the amplified sound in response to the ADC unit, and controls the amplified sounds. Further, the sound collection method according to another embodiment of the present invention using the above apparatus may include: transferring sounds collected by some among the plurality of microphones to the amplification stage and sounds collected by some other ones among the plurality of microphones to the fixed amplification unit, respectively; amplifying the sounds received in the amplification stage at a plurality of amplification factors using the amplification stage and transferring the generated multiple sounds, that is, amplified sounds to the selection unit and, on the other hand, amplifying a single sound received in the fixed amplification unit at a fixed amplification factor and transferring the amplified sound to an ADC unit; separately storing the amplified sounds in the single memory unit using the selection unit, while determining an amplitude of each amplified sound, adding information on the selected one amplified sound to the control signal and transmitting the control signal to the control unit and, on the other hand, storing the amplified sound received in the ADC unit in the memory unit using ADC control signal; searching the memory unit for the amplified sound corresponding to the information included in the control signal while searching the ADC unit for the stored amplified sound, and controlling the amplified sounds by the control unit, whereby sounds collected by some among the plurality of microphones are amplified into multiple sounds, respectively, at a plurality of amplification factors, the amplified sounds are separately stored in the memory unit, while determining an amplitude of each amplified sound and controlling the amplified sound corresponding to the information on the selected one amplified sound and, on the other hand, amplifying sounds collected by some other ones among the plurality of microphones into a single sound, storing the amplified sound and controlling the same, thereby collecting all sounds over a broad area without loss thereof.

### Preferred Embodiment of Invention

Hereinafter, preferred embodiments of the present invention will be described in detail with reference to the accompanying drawings. Herein, terms used in the specification and appended claims are not restrictedly interpreted as typical or dictionary meanings but to have meanings and concepts consistent with technical details of the present invention.

Configurations described in the embodiments of the present specification and illustrated in the drawings are proposed only as preferred embodiments of the present invention and do not represent all of technical features of the present invention. Therefore, various equivalents and modifications of the present invention are possible at a point of time when the present application has been filed.

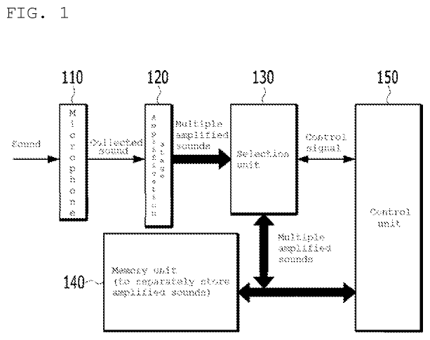

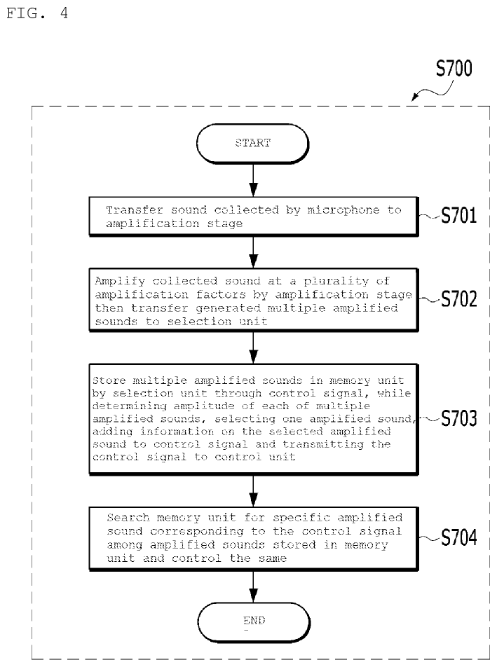

FIG. 1 is a configuration diagram of an apparatus for collecting all sounds generated over a broad area using a single microphone without loss hereof, while FIG. 4 is a flowchart of FIG. 1.

Referring to FIGS. 1 and 4, the present invention provides an apparatus and a method for collection of sound, characterized in that: a microphone 110 may collect all sounds generated over a broad area and transfer the collected sound to an amplification stage 120 (S701); the amplification stage 120 may amplify the collected sound at a plurality of amplification factors and transfer the generated multiple amplified sounds to a selection unit 130 (S702); the selection unit 130 may communicate with a control unit via a control signal in order to separately store the multiple amplified sounds in a memory unit 140, while determining an amplitude of each amplified sound, adding information on the selected one amplified sound to the control signal, and transmitting the control signal to a control unit 150 (S703); and the control unit 150 may search the memory unit 140 for the amplified sound corresponding to the control signal and control the same (S704), thereby collecting all sounds generated over a broad area without loss thereof.

The microphone is a device to collect sound from the surroundings and to convert the same into an electrical signal.

The sound to be collected herein may include sound occurring in a situation such as crime prevention, precaution, etc. Such sound has undefined and non-adjustable features, as well as unspecified and various characteristics, and occurrence of sound cannot be controlled or regulated. Further, since even transient sound is very significant, all sounds should be collected over an area as broad as possible.

The amplification stage may comprise a plurality of amplifiers having different amplification factors, in order to amplify the sound collected by the microphone at different amplification factors of the amplifiers, respectively, and to transfer the generated multiple sounds, that is, amplified sounds to the selection unit. The amplification stage may include a buffer member to transfer the collected sound to the plurality of amplifiers in the amplification stage and a low pass filter (LPF) or a band pass filter (BPF) to amplify a specific frequency bandwidth only, wherein non-amplification or attenuated amplification may also be included.

The multiple amplified sounds may refer to a bundle of amplified multiple sounds generated by amplifying the collected sound at different amplification factors, respectively, using a plurality of amplifiers having such different amplification factors as described above.

The selection unit may communicate with the control unit via a control signal in order to separately store the multiple amplified sounds in the memory unit, while determining the amplitude of each amplified sound and selecting a specific one among the amplified sounds. Herein, a time at which the amplified sound occurs may be stored to be determined, or ID of the selected amplified sound and/or time information thereon may be included in the control signal, which in turn is transmitted to the control unit. Further, the selection unit may be provided with LPF member, BPF member and/or an analog to digital conversion (ADC) member so as to continuously determine the multiple amplified sounds and again select another one among the amplified sounds or store the same in a digital form.

The control signal may include a signal used to store the multiple amplified sounds in the memory unit through communication between the control unit and the selection unit, as well as a signal including ID of the selected amplified sound and/or time information thereon, wherein the time information is information on a time at which the amplified sound occurs and, when storing the multiple amplified sounds in the memory unit, these sounds may be stored such that a storage position and time information on the amplified sound could be identified. Therefore, even when a different amplified sound is again selected, the control signal may be used to control the amplified sound without loss thereof.

The memory unit may communicate with the selection unit and the control unit in order to separately store the multiple amplified sounds therein, wherein time information is also stored.

The control unit may send a control signal to control the selection unit and may search the memory unit for the amplified sound corresponding to the control signal which includes information (ID and/or time information, etc.) on the amplified sound selected by the selection unit and control the amplified sound.

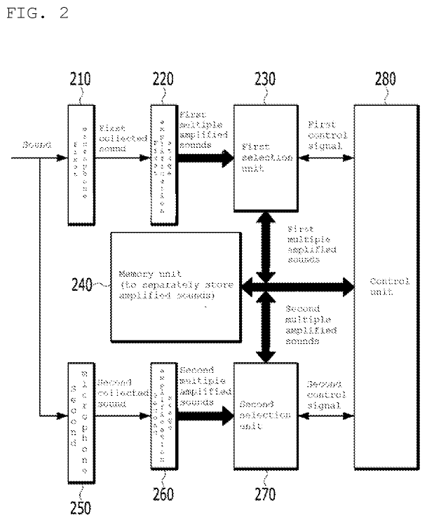

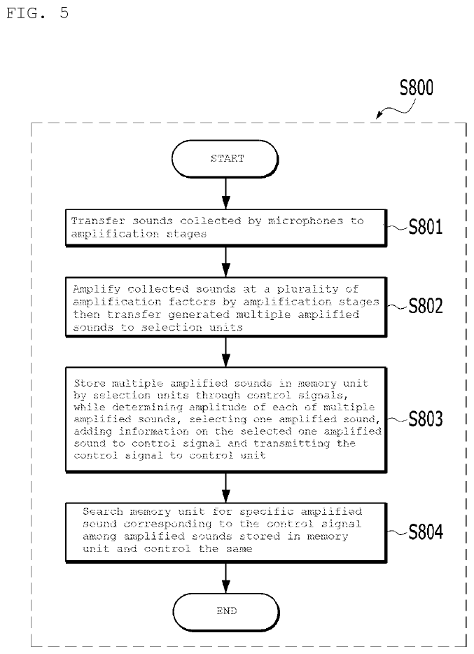

FIG. 2 is a configuration diagram of an apparatus for collection of all sounds generated over a broad area using a plurality of microphones without loss thereof, and FIG. 5 is a flowchart of FIG. 2.

Referring to FIGS. 2 and 5, a plurality of microphones 210, 250 may collect all sounds generated over a broad area and transfer the collected sounds to a plurality of amplification stages 220, 260 (S801); the amplification stages 220, 260 amplify the collected sounds at a plurality of amplification factors and transfer the generated multiple amplified sounds to a plurality of selection units 230, 270 (S802); the selection units 230, 270 may separately store the multiple amplified sounds in a memory unit 240 using the control signals, while determining an amplitude of each amplified sound, adding information of the selected amplified sounds to the control signals and transmitting the control signals to a control unit 280 (S803); and the control unit 280 may search the memory unit 240 for the amplified sounds corresponding to the control signals, respectively, and control the same (S804). Herein, the concept in FIG. 2 is also applicable to three or more microphones.

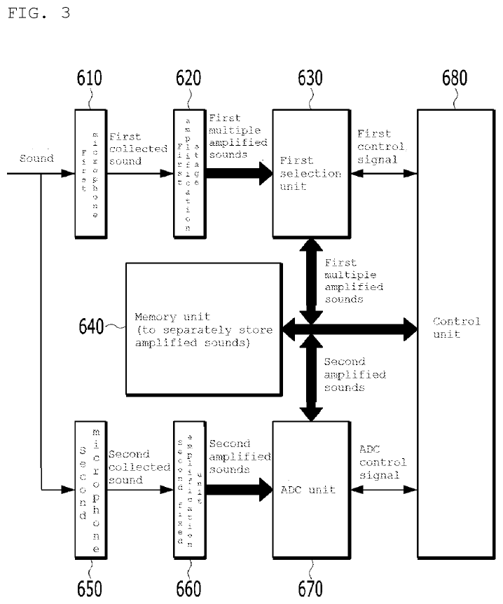

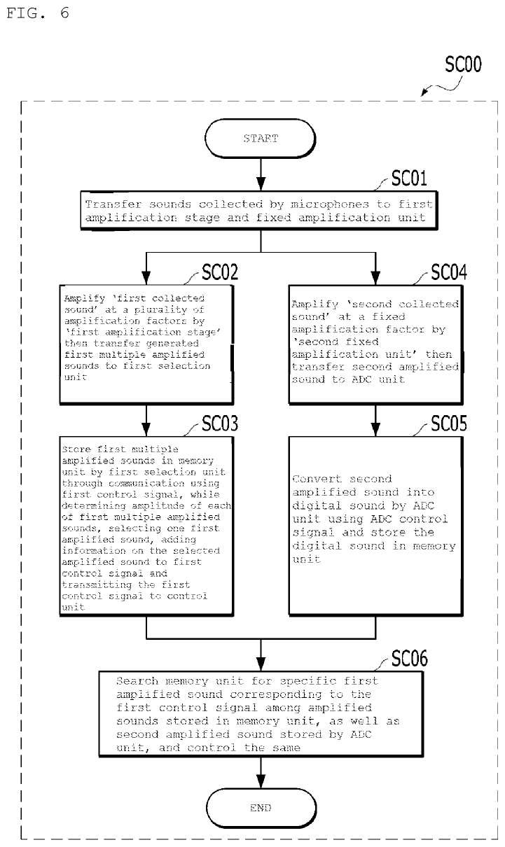

FIG. 3 illustrates a sound collection apparatus according another embodiment of the present invention wherein sound collected by some among the plurality of microphones may be collected via a route involving a plurality of amplifiers, while sounds collected by some other ones among the plurality of microphones may be collected via another route involving a single amplifier, whereby all sounds generated over a broad area may be collected without loss thereof. FIG. 6 is a flowchart of FIG. 3.

Referring to FIGS. 3 and 6, a first microphone 610 and a second microphone 650 may collect sound, and then, the first microphone 610 may transfer a first collected sound to a first amplification stage 620 (SC01); the first amplification stage 620 may amplify the first collected sound at a plurality of amplification factors and transfer the generated first multiple amplified sounds to a first selection unit 630 (SC02); the first selection unit 630 may separately store the first multiple amplified sounds in a memory unit 640 using first control signal, while determining an amplitude of each of the first multiple amplified sounds, adding information on the selected first amplified sound to the first control signal and transmitting the first control signal to a control unit 680 (SC03); and the control unit may search the memory unit for the amplified sound corresponding to the first control signal and control the same (SC06) and, at the same time, the second microphone 650 may transfer a second collected sound to a fixed amplification unit 660 (SC01); the fixed amplification unit 660 may amplify the second collected sound at a fixed amplification factor and transfer the generated second amplified sound to an ADC unit 670 (SC04); the ADC unit 670 may store the second amplified sound in the memory unit 640 using ADC control signal (SC05); and the control unit 680 may search the memory unit 640 for the first amplified sound corresponding to the first control signal and the second amplified sound corresponding to the ADC control signal and control the same (SC06).

The fixed amplification unit 660 may amplify the collected sound at a fixed amplification factor using a single amplifier, wherein non-amplification or attenuated amplification may also be included.

The ADC unit 670 may convert analog type amplified sound into digital sound and store the same in the memory unit. The selection unit of the present invention is not operable to determine the amplitude.

ADC control signal may refer to a control signal by which the control unit operates the ADC unit 670 to convert analog type signal into digital sound and then store the same in the memory unit.

The same concept as in FIG. 3 is applicable even when three or more microphones are used.

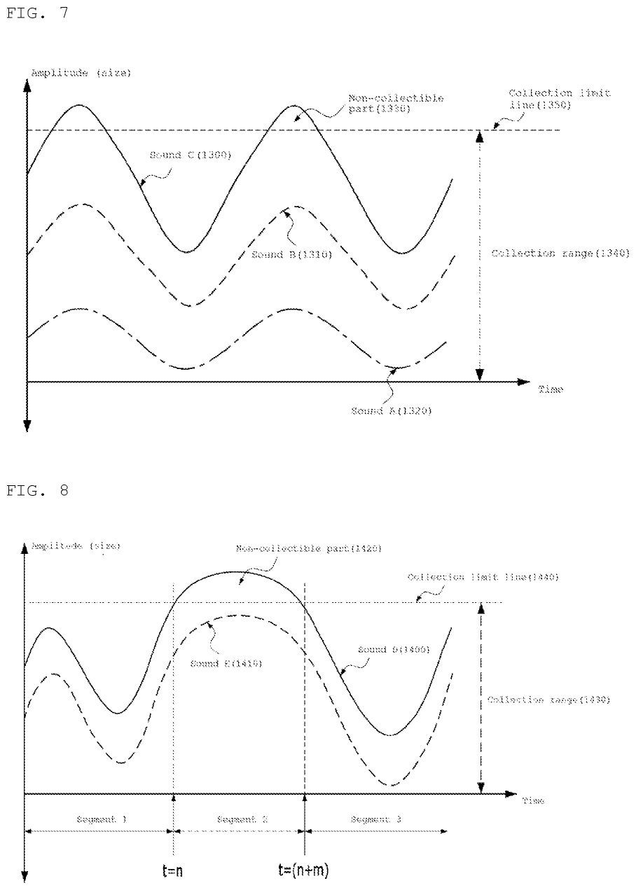

FIG. 7 is a conceptual diagram illustrating waveforms of amplified sounds and a collection range thereof according to the present invention, wherein sound A, sound B and sound C are sounds amplified at different amplification factors from the same sound collected by the amplification stage. In particular, sound A 1320 has a waveform at non-amplification and does not have any portion out of the collection range 1340, however, involves poor discrimination of sounds. Sound B 1310 has a waveform at an appropriate amplification. factor and. shows discrimination of sounds, however, does not have any portion out of the collection range. Further, sound C 1300 has a waveform at a high amplification factor and may have a portion 1330 out of the collection range although high discrimination of sounds is achieved.

Such sounds based on sound sources of sound A, sound B and sound C have problems of: not being defined in size; having a very large range of loudness by different sound sources or a large difference in pitches of the same sound source; transiently occurring and then fading out; wherein a plurality of sounds may be mixed and, if using a single amplification factor, a big sound source-based sound may be out of the collection range thus causing loss of sound; and wherein a small sound source-based sound may not be collected. A solution to overcome the above problems while increasing the discrimination of sounds is to simultaneously amplify sound at different amplification factors, followed by collecting and controlling the amplified sounds.

FIG. 8 is a conceptual diagram illustrating a method of eliminating loss of the sound out of the collection range, caused by a large difference in pitches of sounds from the same sound source according to one embodiment of the present invention, wherein sounds collected from the same sound source have been amplified by the amplification stage to obtain greatly amplified sound D 1400 and moderately amplified sound E 1410, which in turn are stored in the memory unit; when the selection unit communicates with the control unit through a control signal including information on the amplified sound D selected in segment 1, the control unit searches the memory unit for the amplified sound D and controls the same; further, when the selection unit communicates with the control unit through another control signal including information on the amplified sound E again selected in segment 2, the control unit searches the memory unit for the amplified sound E and controls the same; still further, when the selection unit communicates with the control unit through a further control signal including information on the amplified sound D still again selected in segment 3, the control unit searches the memory unit for the amplified sound E and controls the same, thereby collecting and controlling the sounds without loss thereof.

When the segment needs to be separately selected in the present invention, time information is used to connect the sounds without loss thereof. In this case, when a rule is established by the time information in connection with address in the memory unit, the control unit may control the sounds without loss thereof. In this regard, one embodiment of the present invention is shown in Table 1 below.

TABLE 1
How to store sounds based on time information in connection with address
in memory unit according to one embodiment of the present invention

| | Data | | | |
|---|---|---|---|---|
| | amount | Address | | |
| Item | (byte) | in memory | Time | Segment |
| Sound D | 24 M | ADDR = 1 | t = 1 | Time and address |
| | | . . . | | corresponding to |
| | | | | segment 1 in FIG. 8 |
| | | ADDR = n | t = n | |
| | | . . . | | |
| | | ADDR = (n + m) | t = (n + m) | |
| | | . . . | | Time and address |
| | | ADDR = 24 M | t = 24 M | corresponding to |
| | | | | segment 3 in FIG. 8 |
| Sound E | 24 M | ADDR = (1 + 24 M) | t = 1 | |
| | | . . . | | |
| | | ADDR = (24 M + n) | t = n | Time and address |
| | | . . . | | corresponding to |
| | | ADDR = (24 M + | t = (n + m) | segment 2 in FIG. 8 |
| | | n + m) | | |
| | | . . . | | |
| | | ADDR = 48 M | t = 24 M | |

Table 1 is a conceptual chart illustrating a method of storing sound by time information in connection with address in the memory unit according to one embodiment of the present invention, wherein, when a sound frequency bandwidth is limited to 20 KHz, a sampling frequency is limited to 40 KHz and a quantization level is limited to 16 Bits, data generated per second may be 80,000 bytes and a data quantity generated for 5 minutes may come to 24,000,000 bytes. Taking account for the above facts, an address of sound D 1400 may be assigned from ‘ADDR=1’ to ‘ADDR=24 M’ and an address of sound E 1410 may be assigned from ‘ADDR=24 M+1’ to ‘ADDR=48 M’. Therefore, sound D at t=1 may be stored in ‘ADDR=1’ while storing sound E in ‘ADDR=24 M+1’, simultaneously. The address may be sequentially increased over time and the sounds may be simultaneously stored while constantly maintaining a difference in addresses (off-set) between the sound D and the sound E. Further, the above mechanism may also be applied to an apparatus and a method for collection of sound using a plurality of microphones.

Referring to FIG. 8 and Table 1, t=n is a point at which the amplified sound D starts to escape the collection range, t=(n+m) is a last point at which the amplified sound D is out of the collection range. When the selection unit transfers a control signal including information on the amplified sound E again selected at t=n and time information, that is, t=n to the control unit, the control unit may search the memory unit for sound corresponding to ‘ADDR=(24 M+n)’ of the amplified sound E from t=n and start to control the sound. Further, when the selection unit transfers another control signal including information on the amplified sound D again selected at t=n+m+1 and time information, that is, t=n+m+1 to the control unit, the control unit may search the memory unit for sound corresponding to ‘ADDR=(n+m+1)’ of the amplified sound D from t=n+m+1 and control the same.

As shown in FIG. 8, if an amplitude of the amplified sound selected by the selection unit is out of the collection range at any point of time, another amplified sound may be immediately selected, followed by searching the memory unit for the amplified sound again selected as described above and controlling the same from the starting point rather than the point of time at which the amplification is out of the collection range.

According to the above method, the amplified sound D may be controlled in segment 1, the amplified sound E may be controlled in segment 2 and the amplified sound D may be again controlled in segment 3, thereby collecting and controlling sounds without loss thereof.

### INDUSTRIAL APPLICABILITY

As described above, the present invention relates to an apparatus and a method for collection of sound generated over a broad area, in particular, unspecified and various sounds generated in fields of crime prevention, precaution, etc. using a microphone without loss thereof, and provides a means for the sound collection apparatus and method using a single microphone and/or a means for the sound collection apparatus and method using a plurality of microphone.

1. An apparatus for collection of sound, comprising:
a single microphone to transfer sound collected from the surroundings to an amplification stage;
the amplification stage that amplifies the sound transferred from the microphone at a plurality of amplification factors and transfers the generated multiple sounds, that is, amplified sounds to a selection unit;
the selection unit that separately stores the amplified sounds transferred from the amplification stage in a memory unit, while determining an amplitude of each amplified sound, adding information on the selected one amplified sound to a control signal and transmitting the control signal to a control unit;
the memory unit that separately stores the amplified sounds transferred from the selection unit therein; and
the control unit that searches the memory unit for the amplified sound corresponding to the information included in the control signal transmitted from the selection unit and controls the amplified sound,
wherein a single sound collected by the single microphone is amplified into multiple sounds at a plurality of amplification factors, the amplified sounds are separately stored in the memory unit, while determining an amplitude of each amplified sound and controlling the amplified sound corresponding to the information on the selected one amplified sound, thereby collecting all sounds over a broad area without loss thereof.

2. A method for collection of sound, comprising:
(a) transferring sound collected by a single microphone to an amplification stage;
(b) amplifying the sound at a plurality of amplification factors using the amplification stage and transferring the generated multiple sounds, that is, amplified sounds to a selection unit;
(c) separately storing the amplified sounds in a memory unit using the selection unit, while determining an amplitude of each amplified sound, adding information on the selected one amplified sound to a control signal, and transmitting the control signal to a control unit; and
(d) searching the memory unit for the amplified sound corresponding to the information included in the control signal and controlling the amplified sound by the control unit,
wherein a single sound collected by the single microphone is amplified into multiple sounds at a plurality of amplification factors, the amplified sounds are separately stored in the memory unit, while determining an amplitude of each amplified sound and controlling the amplified sound corresponding to the information on the selected one amplified sound, thereby collecting all sounds over a broad area without loss thereof.

3. An apparatus for collection of sound, comprising:
a plurality of microphones to transfer sound collected from the surroundings to a plurality of amplification stages by one to one;
the plurality of amplifiers stages that amplify the sounds transferred from the plurality of microphones by one to one at a plurality of amplification factors and transfer the generated multiple sounds, that is, amplified sounds to a plurality of selection units by one to one;
the plurality of selection units that separately store the amplified sounds transferred from the amplification stages in a memory unit by one to one, while determining an amplitude of each amplified sound, adding information on the plurality of amplified sounds selected by the number of the microphones to a plurality of control signals by one to one and transmitting the control signals to a control unit;
a single memory unit that separately stores the amplified sounds transferred from the selection units therein; and
a single control unit that searches the memory unit for the amplified sounds corresponding to the information included in the control signals transmitted from the selection units by one to one and controls the amplified sounds,
wherein sounds collected by the plurality of microphones are amplified into multiple sounds, respectively, at a plurality of amplification factors, the amplified sounds are separately stored in the memory unit, while determining an amplitude of each amplified sound and controlling the amplified sounds corresponding to the information on the selected multiple amplified sounds, respectively, thereby collecting all sounds over a broad area without loss thereof.

4. A method for collection of sound, comprising:
(a) transferring sounds collected by a plurality of microphones to a plurality of amplification stages corresponding to the microphones by one to one;
(b) amplifying the sounds received in the amplification stages by one to one at a plurality of amplification factors, respectively, using the amplification stages and transferring the generated multiple sounds, that is, amplified sounds to a plurality of selection units by one to one;
(c) separately storing the amplified sounds in a single memory unit using the plurality of selection units, while determining an amplitude of each amplified sound, adding information on the selected multiple amplified sounds to control signals by one to one, and transmitting the control signals to a single control unit; and
searching the memory unit for the amplified sounds corresponding to the information included in the control signals, respectively, and controlling the amplified sounds by the control unit,
wherein sounds collected by the plurality of microphones are amplified into multiple sounds, respectively, at a plurality of amplification factors, the amplified sounds are separately stored in the memory unit, while determining an amplitude of each amplified sound and controlling the amplified sounds corresponding to the information on the selected multiple amplified sounds, respectively, thereby collecting all sounds over a broad area without loss thereof.

5. An apparatus for collection of sound, comprising:
a plurality of microphones to transfer sound collected from the surroundings to an amplification stage and a fixed amplification unit by one to one;
the amplification stage that amplifies the sounds transferred from some among the plurality of microphones at a plurality of amplification factors and transfers the generated multiple sounds, that is, amplified sounds to a selection unit;
the selection unit that separately stores the amplified sounds transferred from the amplification stage in a memory unit, while determining an amplitude of each amplified sound, adding information on the selected one amplified sound to a control signal and transmitting the control signal to a control unit;
the fixed amplification unit that amplifies the sounds transferred from some other ones among the plurality of microphones into a single sound at a fixed amplification factor and transfers the amplified sound to an ADC unit;
the ADC unit that stores the amplified sound transferred from the fixed amplification unit in the memory unit using ADC control signal;
a single memory unit that separately stores the amplified sounds transferred from the selection unit and the amplified sound transferred from the ADC unit, respectively, therein; and
a single control unit that searches the memory unit for the amplified sound corresponding to the information included in the control signal transmitted from the selection unit and the amplified sound in response to the ADC unit, and controls the amplified sounds, wherein sounds collected by some among the plurality of microphones are amplified into multiple sounds, respectively, at a plurality of amplification factors, the amplified sounds are separately stored in the memory unit, while determining an amplitude of each amplified sound and controlling the amplified sound corresponding to the information on the selected one amplified sound and, on the other hand, amplifying sounds collected by some other ones among the plurality of microphones into a single sound, storing the amplified sound and controlling the same, thereby collecting all sounds over a broad area without loss thereof.

6. A method for collection of sound, comprising:
(a) transferring sounds collected by some among a plurality of microphones to an amplification stage and sounds collected by some other ones among the plurality of microphones to a fixed amplification unit, respectively;
(b) amplifying the sounds received in the amplification stage at a plurality of amplification factors, respectively, using the amplification stage and transferring the generated multiple sounds, that is, amplified sounds to a selection unit and, on the other hand, amplifying the sounds received in the fixed amplification unit into a signal sound at a fixed amplification factor and transferring the amplified sound to an ADC unit;
(c) separately storing the amplified sounds in a single memory unit using the selection unit, while determining an amplitude of each amplified sound, adding information on the selected one amplified sound to a control signal and transmitting the control signal to a control unit and, on the other hand, storing the amplified sound received in the ADC unit in the memory unit using ADC control signal; and
(d) searching the memory unit for the amplified sound corresponding to the information included in the control signal while searching the ADC unit for the stored amplified sound, and controlling the amplified sounds by the control unit,
wherein sounds collected by some among the plurality of microphones are amplified into multiple sounds, respectively, at a plurality of amplification factors, the amplified sounds are separately stored in the memory unit, while determining an amplitude of each amplified sound and controlling the amplified sound corresponding to the information on the selected one amplified sound and, on the other hand, amplifying sounds collected by some other ones among the plurality of microphones into a single sound, storing the amplified sound and controlling the same, thereby collecting all sounds over a broad area without loss thereof.
